(19) United States
(12) Patent Application Publication
(10) Pub. No.: US 2009/0139458 A1
(43) Pub. Date: Jun. 4, 2009

(54) Aerating or air bubble collecting device

(76) Inventor: Hsueh Lee Tsai, Yunlin Hsien (TW)

Correspondence Address: CHARLES E. BAXLEY, ESQUIRE, 90 JOHN STREET, SUITE 309, NEW YORK, NY, 10038, US

(21) Appl. No.: 11/998,574

(22) Filed: Nov. 30, 2007

(51) Int. Cl. A01K 63/04

(52) U.S. Cl. 119/263

(57) ABSTRACT

An aerating device for an aquarium includes a carrier, a pumping device attached to the carrier and having a motorized impeller for pumping a water and for minimizing the air in the water into a number or reduced air bubbles, a siphon tube coupled to the pumping device and having a tube member engaged into the aquarium for allowing the water to be drawn into the siphon tube and drawn into the carrier by the impeller, and a partition engaged into the carrier and having a passage for collecting the bubbles, and a receptacle disposed above the passage of the partition for receiving and collecting the bubbles and the dirt or protein carried by the bubbles.

### BACKGROUND OF THE INVENTION

1. Field of the Invention

The present invention relates to an aerating device or air bubble collecting device for an aquarium, and more particularly to an aerating device or air bubble collecting device for attaching to an aquarium and for suitably collecting the carbon dioxide and/or the air bubbles and/or for recycling the air bubbles and/or for collecting the dirt or the protein contained in the water within the container of the aquarium.

2. Description of the Prior Art

Typical aquarium facilities comprise a pump disposed in a chamber of a container for circulating the water contained within the container and for pumping fresh air or carbon dioxide into the container and thus for airing or aerating purposes.

For example, U.S. Pat. No. 7,011,748 to Tsai discloses one of the typical aquariums having an air pumping device and comprising a paddle wheel disposed in a chamber of a container and arranged for impelling the water, and fresh air or carbon dioxide selectively pumped into the container.

However, the air pumping device may only be used to supply the air into the water that is received within the container, but may not be used to suitably minimize and supply the carbon dioxide and/or the air into the water contained within the container and also may not suitably supply the carbon dioxide and/or the air to the water plants or the water weeds received in the container; i.e., the carbon dioxide and/or the air may not be suitably recycled, and the dirt or the protein contained in the water within the container of the aquarium may not be suitably collected.

The present invention has arisen to mitigate and/or obviate the afore-described disadvantages of the conventional water aerating assemblies for aquarium facilities.

### SUMMARY OF THE INVENTION

The primary objective of the present invention is to provide an aerating device or air bubble collecting device for attaching to an aquarium and for suitably collecting the carbon dioxide and/or the air bubbles and/or for recycling the air bubbles and/or for collecting the dirt or the protein contained in the water within the container of the aquarium.

The other objective of the present invention is to provide an aerating device or air bubble collecting device for minimizing and supplying the carbon dioxide and/or the fresh air into the water and for allowing the air and/or the carbon dioxide and/or the oxygen to be suitably supplied to the water plants or the water weeds received in the container.

In accordance with one aspect of the invention, there is provided an aerating device for an aquarium comprising a carrier for attaching to a container of the aquarium and including a chamber formed therein, a pumping device attached to the carrier and including a motorized impeller arranged in the chamber of the carrier for pumping and impelling a water received in the container and for generating bubbles, a siphon tube including a first tube member coupled to the pumping device, and including a second tube member engaged into the container for allowing the water in the container to be drawn into the siphon tube and drawn into the chamber of the carrier by the motorized impeller, a partition engaged into the chamber of the carrier and including a passage formed therein and communicating with the chamber of the carrier for collecting the bubbles, and a receptacle disposed on the partition and disposed above the passage of the partition for receiving and collecting the bubbles.

The receptacle includes a tubular member extended therein for forming an annular chamber between the tubular member and the receptacle, and for forming a chamber in the tubular member which is communicating with the passage of the partition for receiving and collecting the bubbles and a dirt. The receptacle includes a tube disposed in the tubular member and engaged into the passage of the partition for receiving and collecting the bubbles.

The receptacle includes a cover disposed on top of the receptacle and having a number of orifices formed therein for allowing an air to flow into the receptacle. An air supplying member may further be provided and engaged through the cover and into the receptacle and into the chamber of the carrier for supplying an air into the chamber of the carrier.

The receptacle includes an outlet port communicating with the annular chamber of the receptacle and coupled to a hose for allowing the dirt to be drawn out of the annular chamber of the receptacle. The pumping device includes a mouth, the motorized impeller is disposed in the mouth for pumping the water and for minimizing the air bubbles.

The pumping device includes at least one aperture formed in the mouth for allowing the water pumped by the motorized impeller to flow out through the aperture of the mouth and to flow into the chamber of the carrier. The pumping device includes a barrel attached to the mouth of the pumping device and coupled to the first tube member of the siphon tube.

The siphon tube includes a conduit engaged into the first tube member of the siphon tube for directing an air into the siphon tube. The siphon tube includes a valve device attached to the siphon tube and coupled to the conduit and having an entrance for allowing the air to flow into the valve device and the conduit. The siphon tube includes a valve member attached to the valve device for controlling the air into the valve device.

The siphon tube includes an outlet member attached to the conduit and having a perforation formed therein and communicating with the first tube member of the siphon tube. The outlet member includes an outer peripheral flange extended outwardly therefrom for engaging with and for agitating the water drawn by the pumping device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an aerating device or air bubble collecting device for attaching to an aquarium in accordance with the present invention;

FIG. 2 is a partial exploded view of the aerating device or air bubble collecting device;

FIG. 3 is a partial cross sectional view of the aerating device or air bubble collecting device taken along lines 3-3 of FIG. 1;

FIG. 4 is a cross sectional view similar to FIG. 3, illustrating the operation of the aerating device or air bubble collecting device;

FIG. 5 is a perspective view similar to FIG. 1, illustrating the other arrangement of the aerating device or air bubble collecting device;

FIG. 6 is a partial exploded view of the aerating device or air bubble collecting device as shown in FIG. 5;

FIG. 7 is a partial cross sectional view of the aerating device or air bubble collecting device taken along lines 7-7 of FIG. 5; and

FIG. 8 is a partial cross sectional view of the aerating device or air bubble collecting device taken along lines 8-8 of FIG. 5.

### DETAILED DESCRIPTION OF THE PREFERRED EMBODIMENT

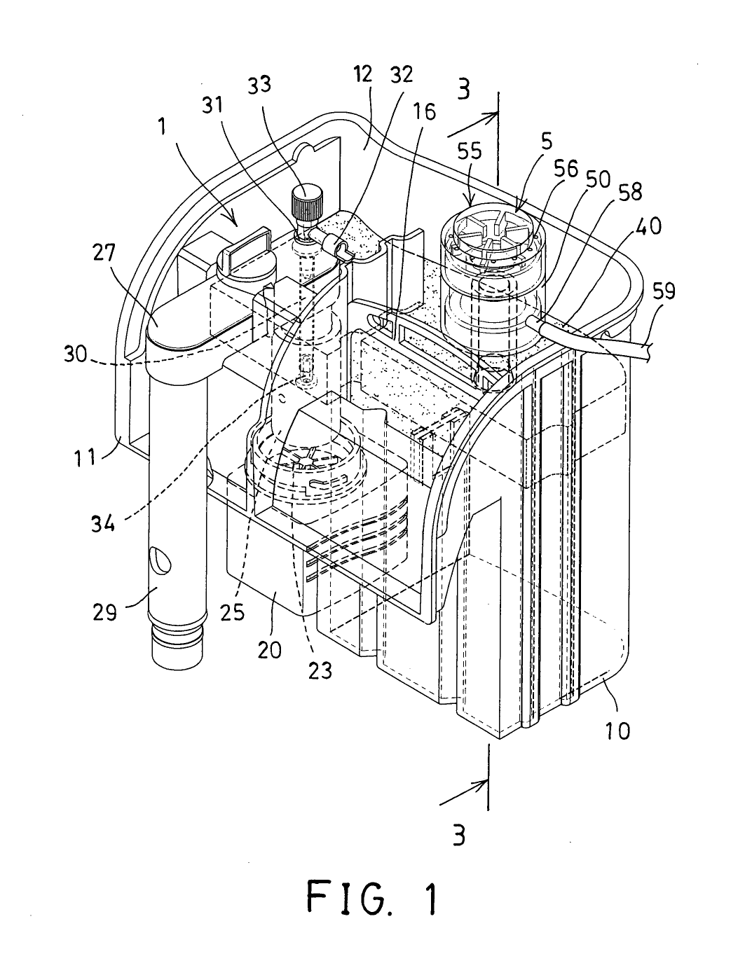

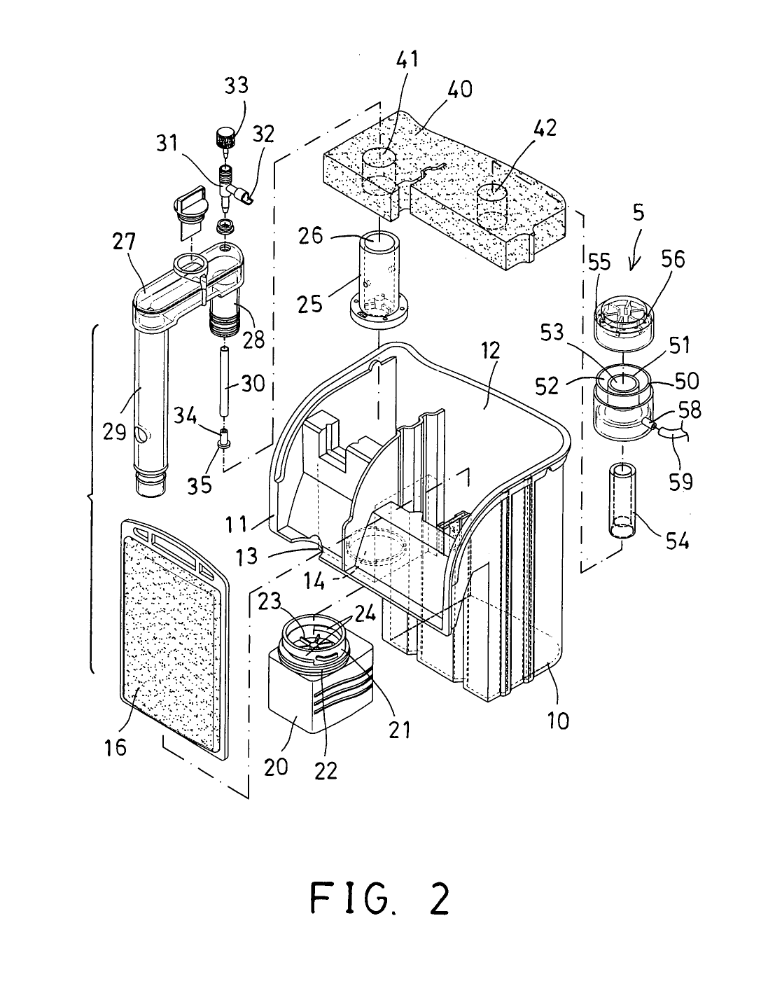

Referring to the drawings, and initially to FIGS. 1-4, an aerating device or air bubble collecting device in accordance with the present invention comprises an aerating device 1 for attaching to an aquarium (not shown) which normally comprises a container including a chamber formed therein for receiving water and fish, and the aerating device 1 includes a carrier 10 having a hook or attaching means or device 11 for readily attaching to the wall or the outer portion of the container without hooks or latches or fasteners or sucking cups or the like, the carrier 10 includes a chamber 12 formed therein, and includes a panel 13 having an opening 14 formed therein (FIGS. 2-4) and communicating with the chamber 12 of the carrier 10. A filter sponge or member 16 (FIGS. 1, 2) may further be provided and disposed in front of an outlet opening 15 for filtering the water.

A pumping device 20 includes a mouth 21 for engaging through the opening 14 of the carrier 10 and for engaging into the chamber 12 of the carrier 10 and for attaching or securing to the carrier 10 with such as latches or fasteners (not shown) or a threading engagement 22, and includes a powered or motorized impeller 23 disposed or arranged in the mouth 21 for pumping or impelling the water, and includes one or more apertures 24 formed in the mouth 21 for allowing the water to be pumped or impelled by the powered or motorized impeller 23 and to flow out through the apertures 24 of the mouth 21 or of the pumping device 20, and then to flow into the chamber 12 of the carrier 10.

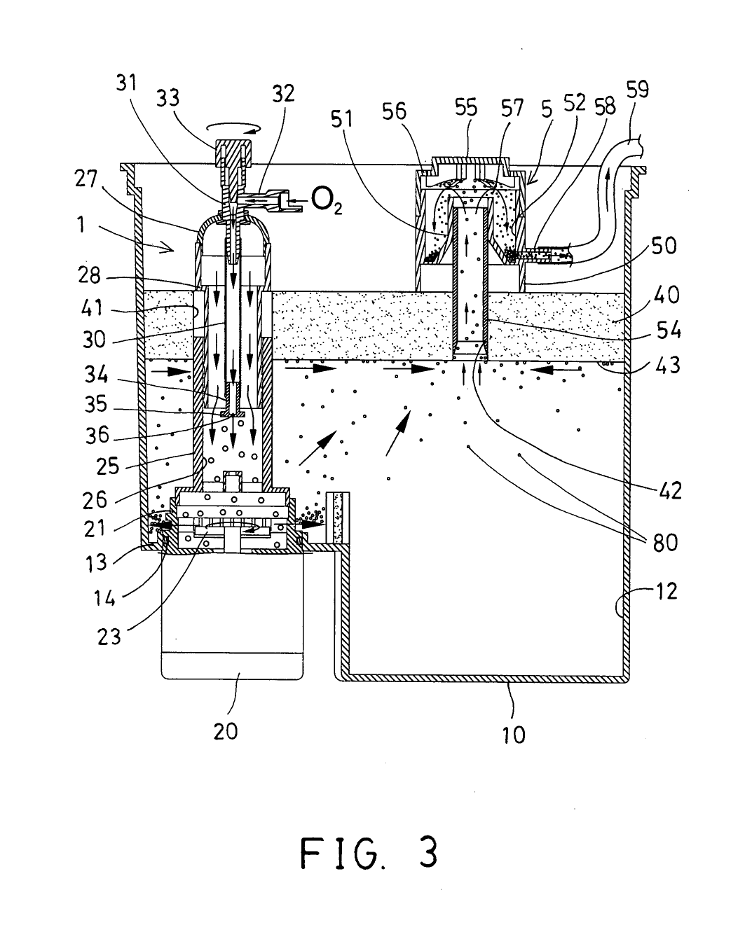

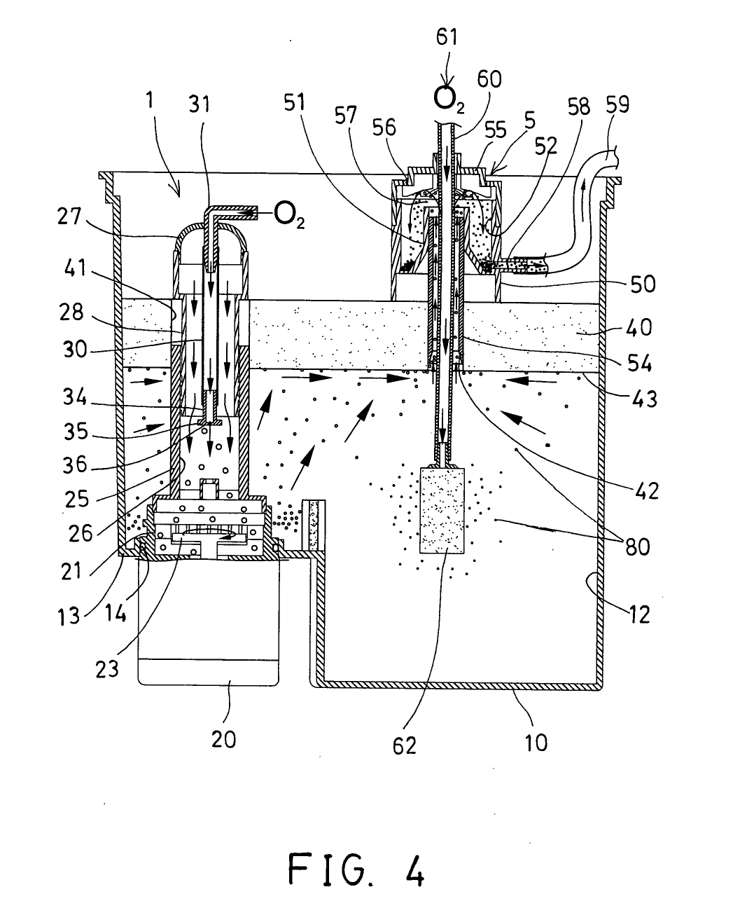

A barrel 25 is disposed or attached onto the mouth 21 of the pumping device 20, and includes a bore 26 formed therein for coupling to a siphon tube 27 which includes a first tube member 28 engaged into or secured or coupling to the barrel 25 of the pumping device 20, and includes a second tube member 29 extended out of the carrier 10 (FIG. 1) and engaged into the container of the aquarium for allowing the water in the container of the aquarium to be drawn into the tube members 28, 29 of the siphon tube 27 and then drawn into the barrel 25 of the pumping device 20 (FIGS. 3-4) by the powered or motorized impeller 23, and to flow out through the apertures 24 of the pumping device 20 and then to flow into the chamber 12 of the carrier 10, the impeller 23 may also agitate or minimize the carbon dioxide and/or the air and/or the gas in the water into a large amount of smaller air bubbles.

A conduit 30 is disposed or engaged into the siphon tube 27, such as the first tube member 28 of the siphon tube 27, and a valve device 31 (FIGS. 1-3) is attached to the siphon tube 27 and coupled to the conduit 30 and includes an entrance 32 for allowing the air or the oxygen in the outer environment to flow into the valve device 31 and the conduit 30 and then to be drawn into the barrel 25 of the pumping device 20 (FIG. 3) by the powered or motorized impeller 23. A valve member 33 may be attached to the valve device 31 for controlling the valve device 31 and for determining the flowing quantity and/or the flowing speed of the air into the valve device 31 and then into the water that is drawn by the powered or motorized impeller 23.

An outlet member 34 is attached to the lower portion of the conduit 30 and includes an outer peripheral flange 35 extended outwardly therefrom for engaging with or for agitating the water drawn into the barrel 25 of the pumping device 20 (FIG. 3), and includes a perforation 36 formed therein (FIGS. 3, 4) and communicating with the first tube member 28 of the siphon tube 27 and the bore 26 of the barrel 25 for allowing the air to be drawn into the bore 26 of the barrel 25. It is to be noted that the fresh air in the outer environment may be supplied or drawn into the entrance 32 of the valve device 31, or an air or gas reservoir (not shown) may be coupled to the entrance 32 of the valve device 31 for supplying the air and/or the gas into the valve device 31.

The carrier 10 includes a partition 40, such as a spongy partition 40 engaged into the chamber 12 of the carrier 10 and laterally or horizontally disposed on the upper portion of the chamber 12 of the carrier 10 for closing the chamber 12 of the carrier 10, and includes an orifice 41 formed therein for receiving or engaging with the barrel 25 and/or the first tube member 28 of the siphon tube 27, and includes a passage 42 formed therein and communicating with the chamber 12 of the carrier 10. As shown in FIGS. 3-4, the air or gas bubbles 80 in the water may flow upwardly toward the bottom surface 43 of the partition 40, and the partition 40 is arranged to have the bubbles 80 flow into the passage 42 of the partition 40. The spongy partition 40 is arranged to allow only the greatly minimized air or gas bubbles 80 to permeate through the spongy partition 40.

A dirt collecting means or device 5 includes a receptacle 50 to be attached or disposed on the partition 40, and particularly disposed above the passage 42 of the partition 40, and includes a tubular member 51 extended in such as the upper portion of the receptacle 50 for forming an annular chamber 52 between the tubular member 51 and the receptacle 50, and for forming a conduit 53 within the tubular member 51 and communicating with the passage 42 of the partition 40, and includes a tube 54 disposed or extended or engaged into the tubular member 51 and the passage 42 of the partition 40 for allowing the air or gas bubbles 80 to flow upwardly through the tube 54 and to flow upwardly beyond or over the tubular member 51. The receptacle 50 may include a cover 55 disposed on top of the receptacle 50 and having a number of orifices 56 formed therein for allowing the air in the environment to flow into the receptacle 50.

As shown in FIGS. 3-4, the upper portion of the tubular member 51 is slightly lower than the upper portion of the receptacle 50 and/or slightly lower than the cover 55 for forming a space or a gap 57 between the tubular member 51 and the cover 55 and thus for allowing the air or gas bubbles 80 to flow upwardly beyond or over the tubular member 51. The upwardly flowing air or gas bubbles 80 may carry the dirt and/or the protein contained in the water for moving the dirt and/or the protein over the tubular member 51 and thus for moving the dirt and/or the protein through the gap 57 between the tubular member 51 and the cover 55 and into the annular chamber 52 of the receptacle 50 and thus for allowing the dirt and/or the protein to be collected within the annular chamber 52 of the receptacle 50.

The receptacle 50 may include an exit or outlet port 58 formed or provided therein and communicating with the annular chamber 52 of the receptacle 50, and coupled to a hose 59 for allowing the dirt and/or the protein to be drawn out of the annular chamber 52 of the receptacle 50, and to be drawn into a dirt collector (not shown). As shown in FIG. 4, an air or gas supplying member 60 may further be provided and engaged through the cover 55 and into the tubular member 51 and/or the tube 54 and into the chamber 12 of the carrier 10, and coupled to an air or gas supplying reservoir or device 61, such as an oxygen reservoir or device 61 which may supply an air or gas into the chamber 12 of the carrier 10, and an air stone 62 may be coupled to the inner end of the air or gas supplying member 60. The air or gas supplying reservoir or device 61 may also be coupled to the valve device 31 for supplying the air or gas into the conduit 30 of the siphon tube 27.

In operation, the water in the aquarium may be drawn into the tube members 28, 29 of the siphon tube 27 and then drawn into the barrel 25 of the pumping device 20 by the powered or motorized impeller 23, and to flow out through the apertures 24 of the pumping device 20 and then to flow into the chamber 12 of the carrier 10, the fresh air in the outer environment may be supplied or drawn into the entrance 32 of the valve device 31 and then into the conduit 30 and then into the water drawn by the powered or motorized impeller 23, and the powered or motorized impeller 23 may also be used to minimize the air or gas bubbles 80. The air or gas bubbles 80 in the water may then flow upwardly toward the bottom surface 43 of the partition 40 and guided to flow into the passage 42 of the partition 40.

The air or gas bubbles 80 in the water may flow upwardly through the tube 54 and may flow upwardly beyond or over the tubular member 51, and may carry the dirt and/or the protein contained in the water for moving the dirt and/or the protein upwardly through the tubular member 51 and then for moving the dirt and/or the protein over the tubular member 51 and thus for allowing the dirt and/or the protein to be collected within the annular chamber 52 of the receptacle 50 and thus for allowing the dirt and/or the protein to be easily drawn out of the annular chamber 52 of the receptacle 50.

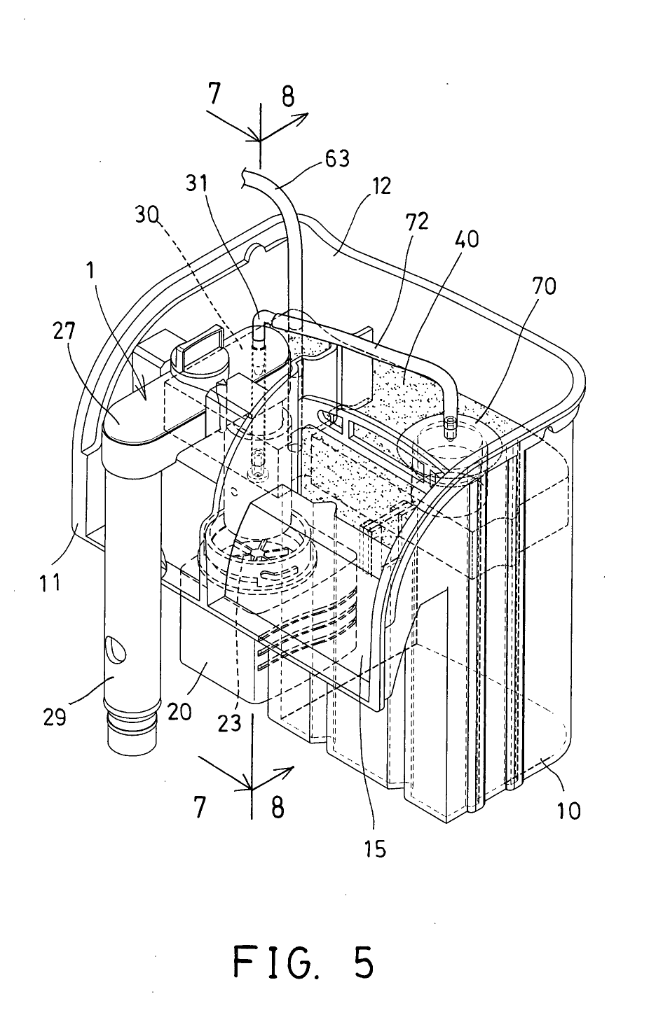

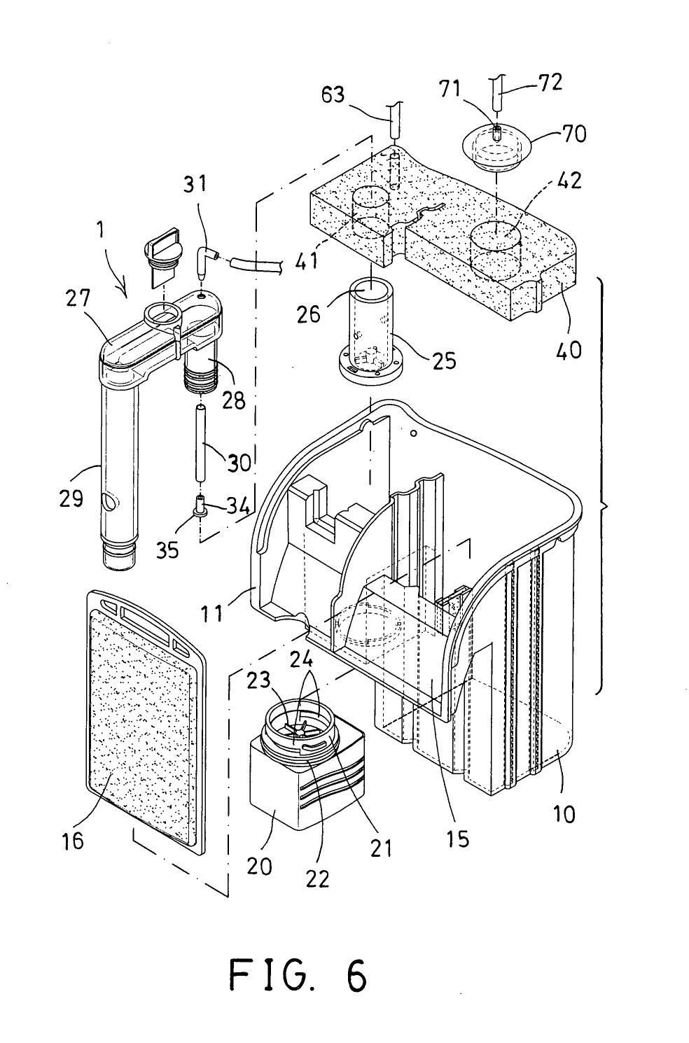

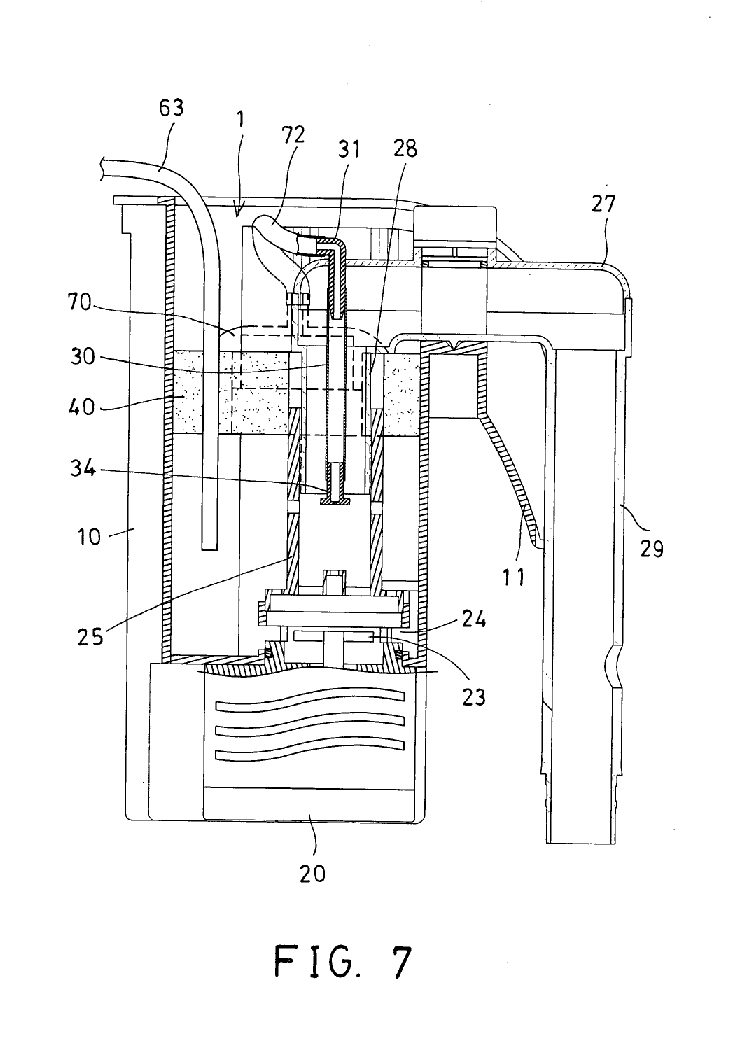

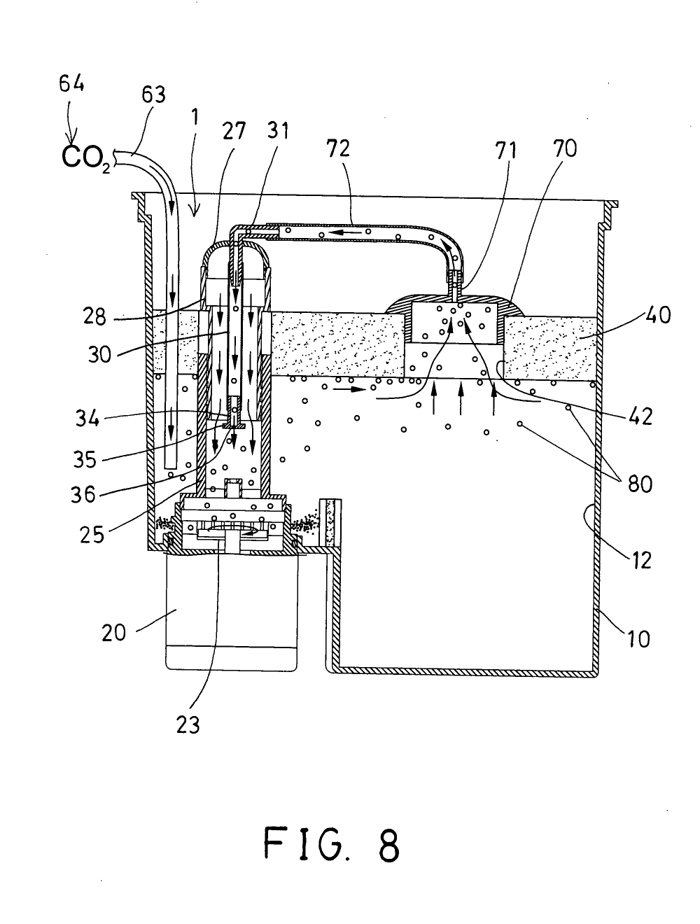

As shown in FIGS. 5-8, the aerating device 1 may further include another air or gas supplying member 63 engaged through the partition 40 and into the chamber 12 of the carrier 10, and coupled to another air or gas supplying reservoir or device 64, such as a carbon dioxide reservoir or device 64 which may supply another air or gas into the chamber 12 of the carrier 10, and may further include another receptacle or cover 70 selectively or changeably disposed on top of the partition 40, and particularly disposed above the passage 42 of the partition 40, and includes a port 71 coupled to the valve device 31 with a hose 72 for gathering and collecting and supplying the air or gas bubbles 80 into the conduit 30.

Accordingly, the air bubble collecting device in accordance with the present invention may be provided for attaching to an aquarium and for suitably agitating the water and the carbon dioxide and/or the air and for suitably supplying the carbon dioxide into the water contained within the container and for suitably supplying the carbon dioxide and/or the air to the water plants or the water weeds received in the container, and/or for minimizing and supplying the reduced carbon dioxide and/or the fresh air to the water plants or the water weeds received in the container.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An aerating device for an aquarium comprising:
a carrier for attaching to a container of the aquarium and including a chamber formed therein,
a pumping device attached to the carrier and including a motorized impeller arranged in said chamber of said carrier for pumping and impelling a water received in the container and for generating bubbles,
a siphon tube including a first tube member coupled to said pumping device, and including a second tube member engaged into the container for allowing the water in the container to be drawn into said siphon tube and drawn into said chamber of said carrier by said motorized impeller,
a partition engaged into said chamber of said carrier and including a passage formed therein and communicating with said chamber of said carrier for collecting the bubbles which carry a dirt, and
a receptacle disposed on said partition and disposed above said passage of said partition for receiving and collecting the bubbles.

2. The aerating device as claimed in claim 1, wherein said receptacle includes a tubular member extended therein for forming an annular chamber between said tubular member and said receptacle, and for forming a chamber in said tubular member which is communicating with said passage of said partition for receiving and collecting the bubbles and the dirt.

3. The aerating device as claimed in claim 2, wherein said receptacle includes a tube disposed in said tubular member and engaged into said passage of said partition for receiving and collecting the bubbles.

4. The aerating device as claimed in claim 2, wherein said receptacle includes an outlet port communicating with said annular chamber of said receptacle and coupled to a hose for allowing the dirt to be drawn out of said annular chamber of said receptacle.

5. The aerating device as claimed in claim 1, wherein said receptacle includes a cover disposed on top of said receptacle and having a plurality of orifices formed therein for allowing an air to flow into said receptacle.

6. The aerating device as claimed in claim 5, wherein an air supplying member is engaged through said cover and into said receptacle and into said chamber of said carrier for supplying an air into said chamber of said carrier.

7. The aerating device as claimed in claim 1, wherein said pumping device includes a mouth, said motorized impeller is disposed in said mouth for pumping the water.

8. The aerating device as claimed in claim 7, wherein said pumping device includes at least one aperture formed in said mouth for allowing the water pumped by said motorized impeller to flow out through said at least one aperture of said mouth and to flow into said chamber of said carrier.

9. The aerating device as claimed in claim 7, wherein said pumping device includes a barrel attached to said mouth of said pumping device and coupled to said first tube member of said siphon tube.

10. The aerating device as claimed in claim 1, wherein said siphon tube includes a conduit engaged into said first tube member of said siphon tube for directing an air into said siphon tube.

11. The aerating device as claimed in claim 10, wherein said siphon tube includes a valve device attached to said siphon tube and coupled to said conduit and having an entrance for allowing the air to flow into said valve device and said conduit.

12. The aerating device as claimed in claim 11, wherein said siphon tube includes a valve member attached to said valve device for controlling the air into said valve device.

13. The aerating device as claimed in claim 10, wherein said siphon tube includes an outlet member attached to the conduit and having a perforation formed therein and communicating with said first tube member of said siphon tube.

14. The aerating device as claimed in claim 13, wherein said outlet member includes an outer peripheral flange extended outwardly therefrom for engaging with and for agitating the water drawn by said pumping device.
